(19) United States
(12) Patent Application Publication
(10) Pub. No.: US 2013/0287326 A1
(43) Pub. Date: Oct. 31, 2013

(54) SPHERICAL PLAIN BEARING WITH SOLID GRAPHITE LUBRICATING PLUGS

(71) Applicants: Matthew Porter, Huntington Beach, CA (US); Robert James, JR., Huntington Beach, CA (US); Michael Gostomski, Colchester, CT (US)

(72) Inventors: Matthew Porter, Huntington Beach, CA (US); Robert James, JR., Huntington Beach, CA (US); Michael Gostomski, Colchester, CT (US)

(73) Assignee: ROLLER BEARING COMPANY OF AMERICA, INC., Oxford, CT (US)

(21) Appl. No.: 13/458,381

(22) Filed: Apr. 27, 2012

(51) Int. Cl. F16C 33/10

(52) U.S. Cl. 384/322

(57) ABSTRACT

A spherical plain bearing includes an inner ring defining a convex outer surface and an outer ring defining a concave inner surface. The outer ring encircles the inner ring and one or more of the outer surface and the inner surface have a plurality of pockets formed therein. A solid graphite plug is disposed in one or more of the plurality of pockets and slidingly engages the outer surface and/or the inner surface.

### FIELD OF THE INVENTION

The present invention is generally directed to a spherical plain bearing having an outer ring at least partially encircling an inner ring and having solid graphite lubricating plugs disposed in pockets formed in the inner ring and/or outer ring and slidingly engaged with mating surfaces of the outer ring and/or the inner ring.

### BACKGROUND OF THE INVENTION

Many types of bearings can be used to support radial, thrust, or combination radial and thrust loads. Such bearings include ball, roller, plain, journal, tapered roller bearings and spherical plain bearings. Spherical plain bearings normally include inner and outer ring members wherein the outer ring member has a spherical concave interior surface that defines a cavity therein, and the inner ring member is disposed in the cavity and has a spherical convex surface that is complementary to, and is dimensioned to match, the interior concave surface of the outer ring member. The concave and convex surfaces are the sliding surfaces or bearing surfaces.

### SUMMARY OF THE INVENTION

According to a first aspect of the present invention, there is provided a spherical plain bearing including an inner ring defining a convex outer surface and an outer ring defining a concave inner surface. The outer ring at least partially encircles the inner ring. The outer surface and/or the inner surface define a plurality of pockets therein. A solid graphite plug is disposed in one or more of the plurality of pockets and slidingly engages the outer surface and/or the inner surface. The solid graphite plug lubricates an interface defined by the outer surface, the inner surface, and/or the graphite plugs to reduce friction there between. In one embodiment, the solid graphite plugs have less than 10 ppm impurities.

In one embodiment, the solid graphite plug defines a predetermined structure in an as manufactured state and maintains the predetermined structure after exposure to a gamma dose rate of up to 3.63×10⁴Rad/hr; a 60-yr equivalent gamma dose of 1.19×10¹⁰ Rads air; and/or a 60-yr neutron fluence dose of 4.64×10¹⁸ n/cm² with neutron energies greater than 1 MeV.

In one embodiment, the inner ring is manufactured from a copper based alloy and the outer ring is manufactured from a stainless steel alloy.

### DESCRIPTION OF THE DRAWINGS

FIG. 1 is a cross sectional view of a spherical plain bearing of the present invention;

FIG. 2A is an end view of the outer ring of the spherical bearing of FIG. 1;

FIG. 2B is another embodiment of the outer ring of the spherical bearing of FIG. 1;

FIG. 2C is another embodiment of the outer ring of the spherical bearing of FIG. 1;

FIG. 3 is cross sectional view of a portion of another embodiment of the spherical plain bearing of the present invention;

FIG. 4A is an enlarged view of a portion of the spherical plain bearing of FIG. 1 with the plugs installed flush with the outer surface;

FIG. 4B is an enlarged view of a portion of the spherical plain bearing of FIG. 1 with the plugs protruding from the outer surface;

FIG. 5 is a perspective view of a solid graphite plug of the spherical bearing of FIGS. 1 and 2;

FIG. 6 is a side view of the solid graphite plug of the spherical bearing of FIGS. 1 and 2;

FIG. 7 is a side view of another embodiment of the solid graphite plug of the spherical bearing of FIGS. 1 and 2;

FIG. 8 is a side view of another embodiment of the solid graphite plug of the spherical bearing of FIGS. 1 and 2;

FIG. 9 is an end view of the inner ring of the spherical bearing of FIG. 1;

FIG. 10 is an enlarged schematic view of a portion of the inner ring of FIG. 9;

FIG. 11 is a perspective view of a steam generator for an nuclear power plant with lateral supports having the spherical plain bearing of FIG. 1 installed in the supports;

FIG. 12 is a perspective view of a reactor coolant pump for a nuclear power plant with lateral supports having the spherical bearing of FIG. 1 installed in the supports; and

FIG. 13 is an exploded view of a portion one of the lateral supports shown in FIGS. 11 and 12, with a spherical bearing of FIG. 1.

### DETAILED DESCRIPTION

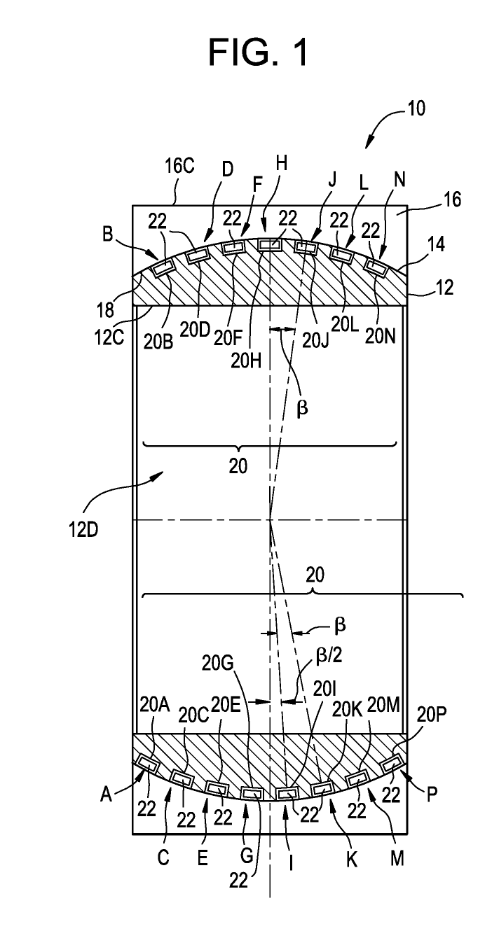

As shown in FIG. 1 a spherical bearing for use in structural supports, such as but not limited to those used in nuclear power plant components including but not limited to components located inside a containment building, a radiation area and/or contamination area, is generally designated by the numeral 10. The spherical bearing 10 includes an inner ring defining a convex outer surface 14 (e.g., a spherical contour). The spherical bearing 10 includes an outer ring 16 defining a concave inner surface 18 (e.g., a spherical contour). The outer ring 16 at least partially encircles the inner ring 12. The outer surface 14 defines a plurality of pockets 20 formed therein. A lubricious solid graphite plug 22 is disposed in each of the pockets and slidingly engages the inner surface 18. As described herein, in one embodiment, the solid graphite plugs 22 have less than 10 ppm impurities. Although, the graphite plugs 22 are described as having less than 10 ppm impurities, the present invention is not limited in this regard as other impurity limits may be employed including but not limited to those greater or less than 10 ppm, for example 15 ppm or 5 ppm.

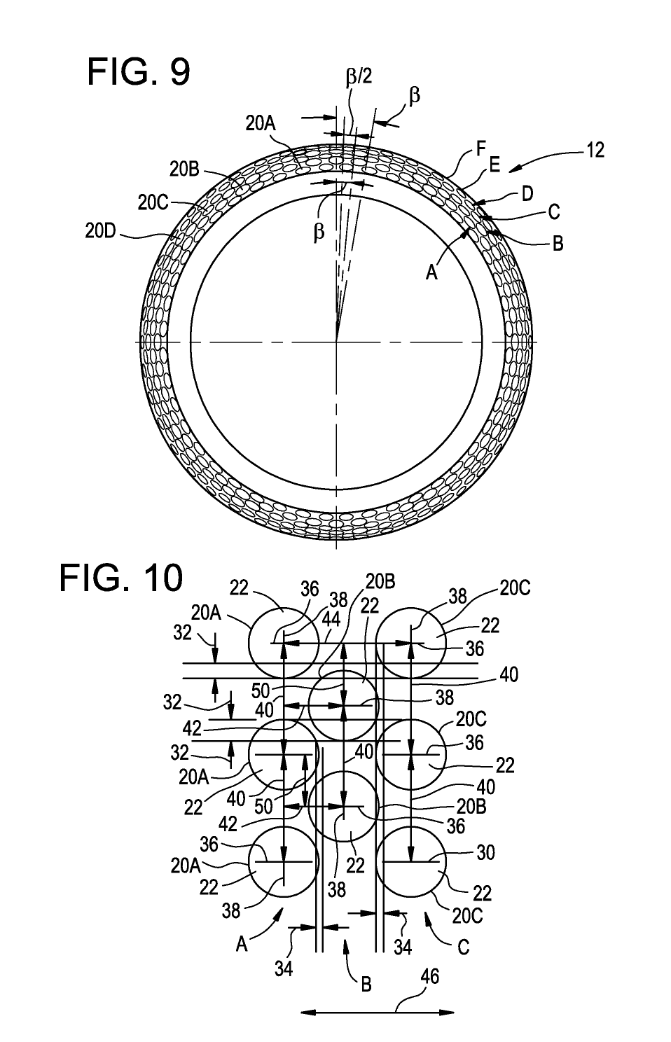

As illustrated in FIGS. 1, 9 and 10 the pockets 20 are arranged in a pattern defined by fifteen circumferentially extending rows designated by the letters A, B, C, D, E, F, G, H, I, J, K, L, M, N and P. The pockets 20 are designated with a suffix letter corresponding to the rows A, B, C, D, E, F, G, H, I, J, K, L, M, N and P. Each of the pockets 20A, 20C, 20E, 20G, 20I, 20K, 20M and 20P of the rows A, C, E, G, I, K, M, and P, respectfully, are angularly spaced apart from one another by an angular spacing β. Each of the pockets 20B, 20D, 20F, 20H, 20J, 20L and 20N of the rows B, D, F, H, J, L and N, respectfully, are angularly spaced apart from one another by the angular spacing β. The angular spacing β is defined such that the pockets 20 in adjacent rows (e.g., A and B) have a circumferentially projected overlap 32 and the pockets in adjacent rows are circumferentially offset by about one half the angular spacing β (designated by (β/2). In addition, the rows A, C, E, G, I, K, M, and P are spaced apart from the rows B, D, F, H, J, L and N, respectively such that there exists an axial projected overlap 34 perpendicular to the angular spacing β, between the pockets 20A, 20C, 20E, 20G, 20I, 20K, 20M and 20P and the pockets 20B, 20D, 20F, 20H, 20J, 20L and 20N, respectively. While the pockets 20 and graphite plugs 22 are shown and described as being arranged in fifteen rows, the present invention is not limited in this regard as the pockets and graphite plugs may be configured in any number of rows, pattern, patterns or randomly.

In one embodiment, the circumferentially projected overlap 32 and the axial projected overlap 34 is about 0.01 to about 0.03 inches. In one embodiment, the angular spacing is about 7.7 degrees. While the circumferentially projected overlap 32 and the axial projected overlap 34 is shown and described as being about 0.01 to about 0.03 inches, the present invention is not limited in this regard as any pattern, overlap or no overlap may be employed without departing from the broader aspects defined herein. Although, the angular spacing β is shown and described as being 7.7 degrees, the present invention is not limited in this regard as other angular spacing may be employed including but not limited, to 7.714, 8.0, 8.286, 10, 10.80 and 12 degrees. In one embodiment, the angular spacing β differs from row to row and/or circumferentially around the inner ring 12 or the outer ring 16.

Referring to FIG. 10, a centerline 36 of each of the pockets 20A is circumferentially spaced apart from the centerline 36 of an adjacent pocket 20A by a predetermined distance 40. The centerline 36 of each of the pockets 20B is spaced apart from the centerline 36 of an adjacent pocket 20B by a predetermined distance 40. In each of the rows C, D, E, F, G, H, I, J, K, L, M, N and P, adjacent ones of the pockets 20C, 20D, 20E, 20F, 20G, 20H, 20I, 20J, 20K, 20L, 20M, 20N and 20P, respectfully, are also spaced apart from one another by the predetermined distance 40. In addition, the centerlines 38 of the pockets 20A are spaced apart from the centerlines 38 of the pockets 20B in an axial direction designated by the arrow 46, a distance 42. The centerlines 38 of the pockets 20A are spaced apart from the centerlines 38 of the pockets 20C by a distance 44. In addition, each of the centerlines 36 of the pockets 20A, 20C, 20E, 20G, 20I, 20K, 20M and 20P is circumferentially offset from the pockets 20B, 20D, 20F, 20H, 20J, 20L and 20N by a distance 50 that is equal to about half of the distance 40.

In one embodiment, about 35 to about 50 percent of the outer surface 14 is covered with pockets 20 having the graphite plugs 22 disposed therein. In one embodiment, about 45 to 48 percent of the outer surface 14 is covered with pockets 20 having the graphite plugs 22 disposed therein. While about 35 to 50 percent and 45 to 48 percent of the outer surface 14 is shown and described as being covered with the pockets 20 having the graphite plugs disposed therein, the present invention is not limited in this regard as about 35 to about 50 percent, 45 to about 48 percent or other percentages of the inner surface 18 can be covered with pockets 20 with or without having the graphite plugs 22 disposed therein and other percentages of the outer surface 14 can be covered with pockets 20 with or without having the graphite plugs 22 disposed therein.

In one embodiment, the pockets 20 are arranged in a random configuration in the outer surface 14. In another embodiment, the pockets 20 are arranged on the outer surface 14 without the circumferentially projected overlap 32 and/or the axial projected overlap 34.

The solid graphite plugs 22 are manufactured from a nuclear grade solid graphite material having a total porosity of about 23 percent. The less than 10 ppm limit on impurities in the solid graphite plug 22 includes less than 1 ppm of aluminum, boron, calcium, iron, silicon, vanadium and/or titanium. The solid graphite plugs 22 also have predetermined properties including a compressive strength of about 7,500 psi, a tensile strength of 2,500 psi, a flexural strength of about 4,500 psi, a modulus of elasticity of about 1.8×10⁶ psi, a coefficient of thermal expansion of about 1.1×10⁻⁶ in/in/° F., a thermal conductivity of about 80 Btu/hr-ft-° F., a density of about 1.74 g/cc, a sclerescope hardness of about 35 and an operational temperature limit of 800° F. While the graphite plugs 22 are described as having a total porosity of 23 percent, the present invention is not limited in this regard as other porosity percentages may be employed include those greater or less than 23 percent, such as but not limited to 5, 10, 15, 20, 25, 30, 35 and 40 percent.

In addition, the solid graphite plugs 22 define a predetermined structure including the 23% porosity and have the above listed properties in an as manufactured state. After exposure to a gamma dose rate of up to 3.63×10⁴ Rad/hr the graphite plugs 22 maintain essentially the same predetermined structure and properties as in the manufactured state. After exposure to a 60-yr equivalent gamma dose of 1.19×10¹⁰ Rads air the graphite plugs 22 maintain the essentially the same predetermined structure and properties as in the manufactured state. After exposure to a 60-yr neutron fluence dose of 4.64×10¹⁸ n/cm² with neutron energies greater than 1 MeV the graphite plugs 22 maintain essentially the same predetermined structure and properties as in the manufactured state. After exposure to a temperature of up to 550° F. the graphite plugs 22 maintain essentially the same predetermined structure and properties as in the manufactured state. After exposure to a fluid having a pH of about 4.0 to about 4.5 (e.g., reactor coolant) the graphite plugs 22 maintain the essentially the same predetermined structure and properties as in the manufactured state. After submergence in a fluid (e.g., submergence below about 111 feet of a fluid such as reactor coolant) the graphite plugs 22 maintain the essentially the same predetermined structure and properties as in the manufactured state.

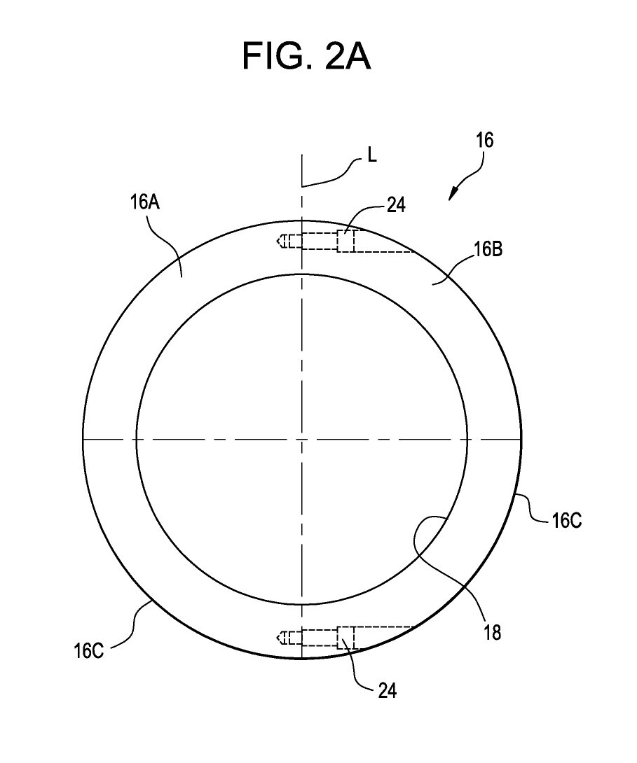

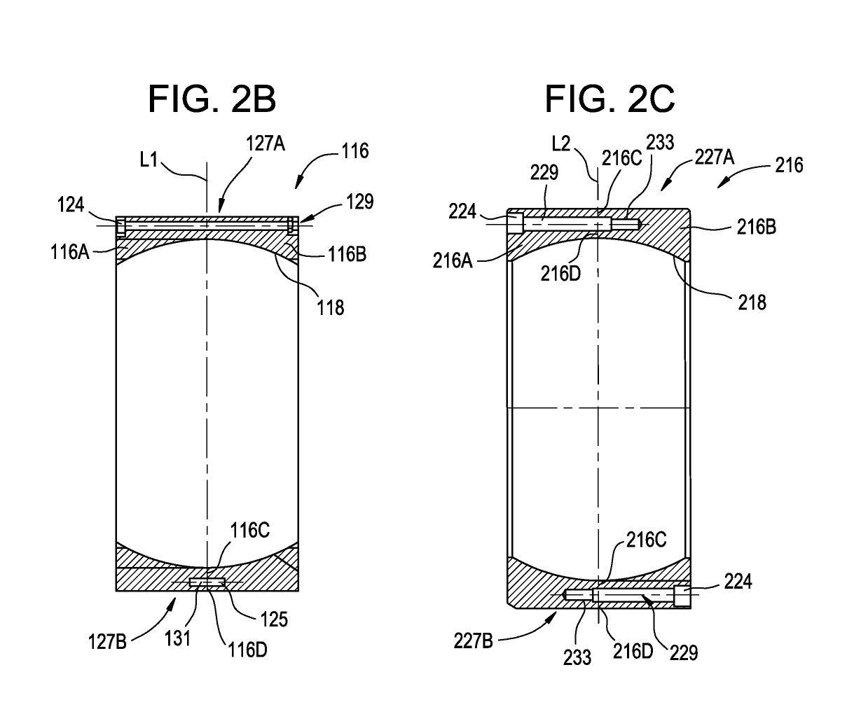

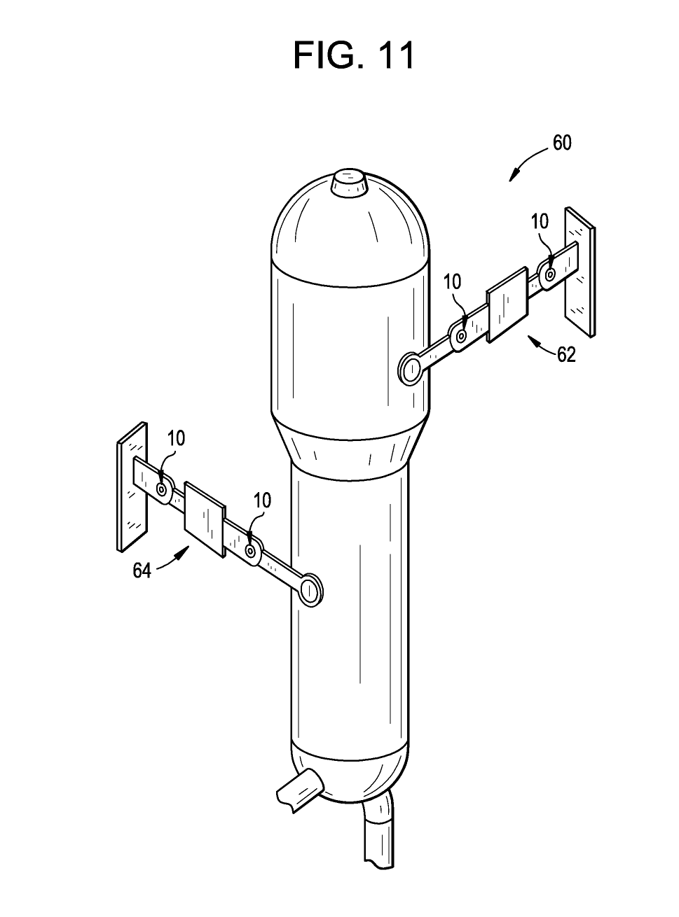

In the embodiment illustrated in FIG. 2A, the outer ring 16 is an axially split ring, along a reference plane L, having a first segment 16A and a second segment 16B, removably secured to one another by suitable fasteners 24, such as but not limited to a bolt. The fasteners 24 are used to facilitate assembly and transport of the bearing 10 to hold the first and second segments 16A and 16B in correct alignment and to hold the graphite plugs 22 in the pockets 20 so that the bearing can be inserted into a housing such as a support as described below with reference to FIGS. 11-13. For example, during assembly the graphite plugs 22 are installed in the pockets 20, after which the first and second segments 16A and B are positioned around the inner ring 12. The first and second segments 16A and 16B are removably secured to one another with the fasteners 24. While the first and second segments 16A and 16B are shown and described as being removably secured to one another by the fasteners 24, the present invention is not limited in this regard as the first and second segments can be removably secured to one another by other by other means including but not limited to multiple fasteners, tack welding and electron beam welding.

While FIG. 2A shows the outer ring 16 being axially split, along the reference plain L, into the first segment 16A and the second segment 16B, the present invention is not limited in this regard as other split configurations may be employed, including but not limited to a circumferentially split ring (FIGS. 2B and 2C), a fractured split ring, and a ring having more than two splits. For example, the outer ring 116 illustrated in FIG. 2B is circumferentially split, along a reference plane L1, into a first segment 116A and a second segment 116B. FIG. 2B is similar to the outer ring 16 of FIG. 2A. Accordingly like elements are designated with like element numbers preceded by the numeral 1. One end 127A of the outer ring 116 has a bore 129 extending through both of the first and second segments 116A and 116B. An opposing end 127B of the outer ring 116 has a bore 131 extend partially into the opposing faces 116C and 116D of the outer ring. A pin 125 is position in the bore 131. A fastener 124 extends through the bore 129 and removably secures the first and second segments 116A and 116B to one another. FIG. 2C is similar to the outer ring 116 of FIG. 2B. Accordingly like elements are designated with like element numbers starting with the numeral 2 instead of the numeral 1. FIG. 2C illustrates another embodiment of the outer ring 216 having a circumferential split along reference plane L2. However, one end 227A of the outer ring 216 has a through bore 229 extending though the segment 216A and a female threaded partial bore 233 extending into the face 216D. The other end 227B of the outer ring 216 has a through bore 229 extending though the segment 216A and a female threaded partial bore 233 extending into the face 216C. A fasteners 224 extends through each of the bores 229 and is screwed into the respective female threaded partial bore 233 to removably secure the first and second segments 216A and 216B to one another.

In one embodiment, the outer ring 16 is manufactured from a stainless steel, for example, type 316, type 304 and 17-4 PH stainless steel.

In one embodiment, the inner ring 12 is manufactured from a copper alloy, such as but not limited to UNS C86300 Manganese Bronze, UNS C95400 Aluminum Bronze, UNS C95400HT Heat Treated Aluminum Bronze, UNS C95500 Nickel Aluminum Bronze, UNS C95500HT Heat Treated Nickel Aluminum Bronze, UNS C96900 Spinodally Hardened Copper Alloy (ToughMet 3CX), UNS C96900 Toughmet or UNS C72900 Spinodally Hardened Copper Alloy (ToughMet 3AT).

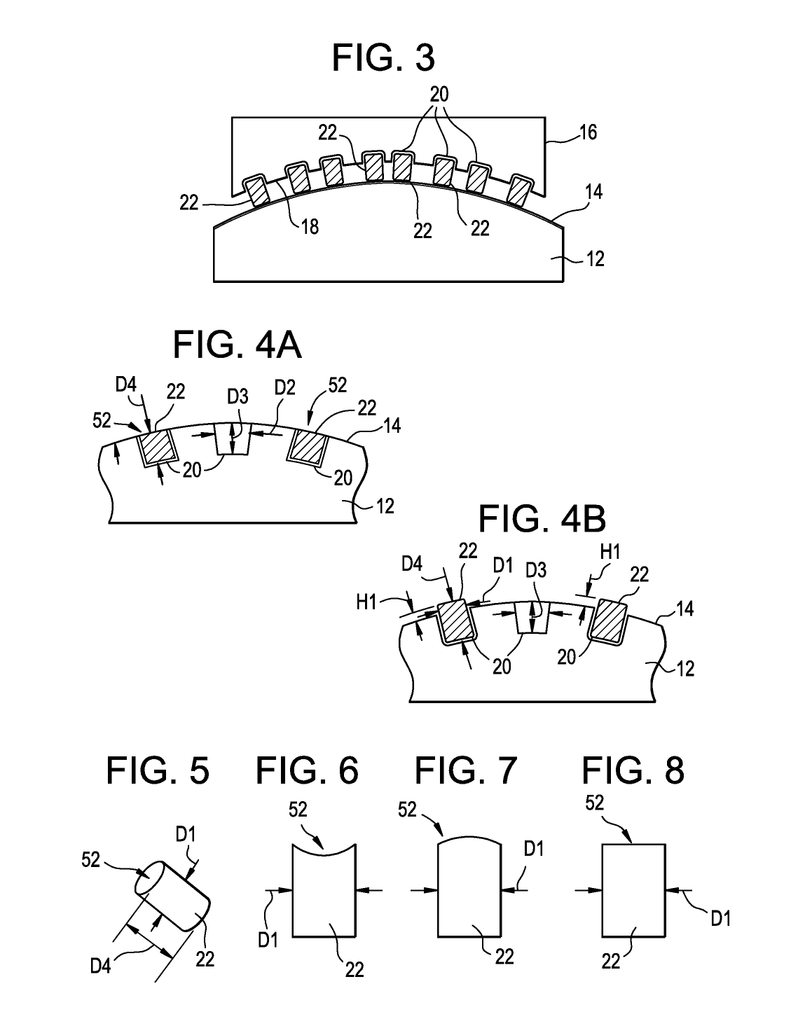

While the inner ring 12 is described as being manufactured from a copper alloy and the outer ring 16 being manufactured from a stainless steel, the present invention is not limited in this regard as other materials may be employed including but not limited to the inner ring 12 being manufactured from a stainless steel and the outer ring 16 being manufactured from a copper alloy. In addition, while the outer surface 14 of the inner ring 12 is shown and described as including a plurality of the pockets 20 formed therein, one of the solid graphite plugs 22 being disposed in each of the pockets and the graphite plugs slidingly engaging the inner surface 18, the present invention is not limited in this regard. For example, as illustrated in FIG. 3 the pockets 20 are formed in the inner surface 18 of the outer ring 16 and the solid graphite plugs 22 are disposed therein and slidingly engage the outer surface 14 of the inner ring 12. In one embodiment, the pockets 20 are formed in both the inner surface 18 and the outer surface 14 with one of the graphite plugs 22 disposed in one or more of the pockets.

Referring to FIGS. 4A, 4B and 5-8 the graphite plugs 22 are generally cylindrical and have an outside diameter D1 and the pockets 20 have an inside diameter D2.

In one embodiment, the diameter D1 is 0.502 inches to 0.506 inches and D2 is 0.501 inches to 0.503 inches. In one embodiment, less than 5 percent of the graphite plugs 22 have a diameter D1 less than 0.502 or greater than 0.504 inches. In one embodiment, the diameter D1 is 0.503 to 0.504 inches. The graphite plugs 22 are manufactured within the tolerance range of D1 of 0.502 inches to 0.506 inches. Thus the diameter D1 of each of the graphite plugs 22 is a diameter 0.502 inches to 0.506 inches. For example, some of the graphite plugs 22 have a diameter of 0.502 inches, some have a diameter of 0.503 inches, some have a diameter of 0.504 inches, some have a diameter of 0.505 inches, and some have a diameter of 0.506 inches and others have diameters within the 0.502 inches to 0.506 inches range. The graphite plugs 22 have a length D4 and are generally cylindrical (FIG. 5). In one embodiment, the length D4 is about 0.28 inches to about 0.375 inches.

The pockets 20 are formed within the tolerance range of D2 of 0.501 inches to 0.503 inches. Thus the diameter D2 of each of the pockets 20 is a diameter 0.501 inches to 0.503 inches. For example, some pockets 20 have a diameter of 0.501 inches, 0.502 inches, and 0.503 inches and other diameters encompassed by the 0.501 inches to 0.503 inches range. Thus depending on the diameter D2 of the pocket 20 and the diameter D1 the graphite plugs 22, some of the graphite plugs have a clearance fit of up to 0.001 inches (i.e., D1 minimum of 0.503 inches minus D2 maximum of 0.501 inches) in the pocket and some of the graphite plugs have an interference fit of up to 0.005 inches (i.e., D1 maximum of 0.506 inches minus D2 minimum of 0.501 inches). The pockets 20 have a depth D3. In one embodiment, the depth D3 is about 0.28 inches. In one embodiment, the graphite plugs 22 having the interference fit are disposed in axially outermost rows A, B, N and P. Thus, during operation or accident conditions when the spherical bearing 10 heats up (e.g., to 550° F.) the pocket 20 expand and some of the graphite plugs 22 could loosen and dislodge from the pockets 20, the graphite plugs 22 disposed in axially outermost rows A, B, N and P remain secured in their respective pockets and retain the remainder of the graphite plugs within a boundary defined by the outermost rows A, B, N and P. While the diameter D1 is described as being 0.502 inches to 0.506 inches, the diameter D2 is described as being 0.501 inches to 0.503 inches, the depth D3 is described as being about 0.28 inches, the length D4 is described as being about 0.28 inches to about 0.375 inches, the present invention is not limited in this regard as the diameters D1, D2 and D3 and the length D4 may be of any suitable magnitude. Although the graphite plugs 22 are described as being generally cylindrical, the present invention is not limited in this regard as graphite plugs of any configuration or shape may be employed including, but not limited to oval, rectangular and hexagonal configurations.

As illustrated in FIG. 4A, the graphite plugs 22 have a distal end 52 that is flush with the outer surface 14 and conforms with the contour of the outer surface and/or the inner surface 18. In the embodiment illustrated in FIG. 4B the graphite plugs 22 protrude from the respective pocket 20 by a distance H1. In one embodiment, the distance H1 is about 0.01 to about 0.03 inches. Although the distance H1 is described as being about 0.01 to about 0.03 inches, the present invention is not limited in this regard as H1 may be of any suitable magnitude. While the distal end 52 is shown and described as conforming with the contour of the outer surface 14 and/or the inner surface 18, the present invention is not limited in this regard as distal end other shapes including, but not limited to, a concave shape (see FIG. 6), a convex shape different than the contour of the outer surface 14 (see FIG. 7) or the inner surface 18 and a flat contour (see FIG. 8).

As illustrated in FIG. 11, a steam generator for a nuclear power plant is generally designated by the numeral 60. The steam generator 60 is located inside a containment vessel (not shown). The steam generator 60 includes an upper lateral support 62 and an intermediate lateral support 64, each of which accommodate misalignment and/or rotation of the steam generator during heat-up and cool-down cycles and during accident conditions. Each of the upper lateral support 62 and the intermediate lateral support 64 extend between and are secured to the steam generator 60 and a foundation (not shown).

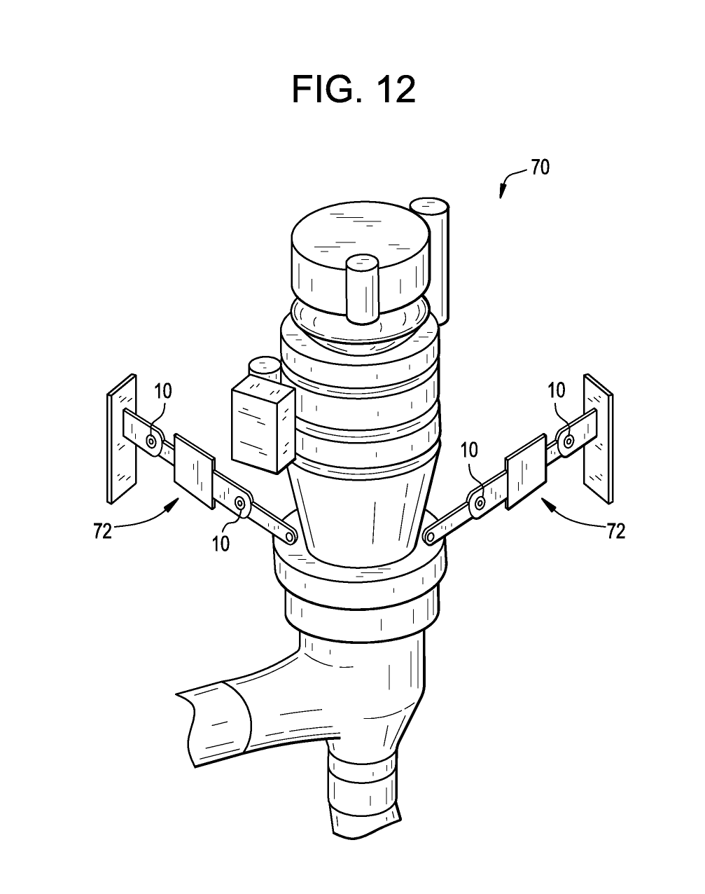

Referring to FIG. 12 a reactor coolant pump is generally designated by the numeral 70. The reactor coolant pump 70 is located inside a containment vessel (not shown). The reactor coolant pump 70 is shown having three lateral supports 72 for accommodating misalignment and/or rotation of the steam generator during heat-up and cool-down cycles and during accident conditions. Each of the lateral supports 72 extend between and are secured to the reactor coolant pump and the foundation (not shown).

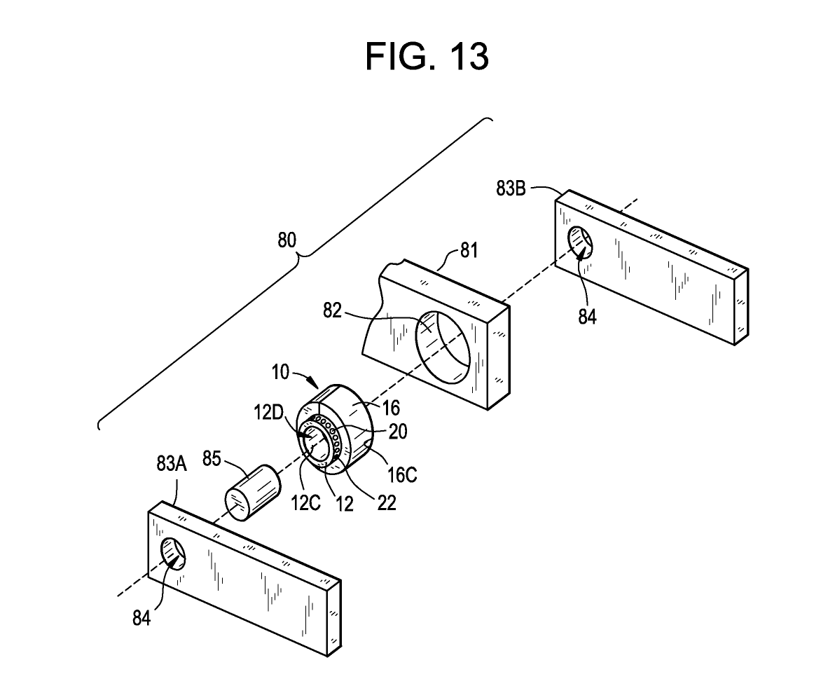

Each of the upper lateral support 62, the intermediate lateral support 64, and the lateral supports 72 have one or more of the spherical bearings 10 installed therein and moveably link portions of thereof to one another as described herein. For example, with reference to FIG. 13, each of the upper lateral support 62, the intermediate lateral support 64, and the lateral supports 72 include a strut assembly 80 including a strut member 81 having a bore 82 extending therethrough. One of the spherical bearings 10 is disposed in the bore 82, for example by press fitting an exterior surface 16C of the outer ring 16 into the bore 82. The inner ring 12 has a substantially cylindrical interior surface 12C defining a bore 12D extending through the inner ring. The strut assembly 80 includes a pair of flanges 83A and 83B, each of which have a bore 84 extending therethrough. A pin 85 extends through the bore 12C of the inner ring 12 and is press fit into the bores 84 of the flanges 83A and 83B. The spherical bearing 10 accommodates misalignment and/or rotation of the strut member 81 relative to the flanges 83A and 83B. While the spherical bearing 10 is described as being press fit into the bore 82, the present invention is not limited in this regard as other methods of installation may be employed including but not limited to slip fitting the spherical bearing 10 into the bore 82.

### Example 1

The inventors performed testing on a flat plate test specimen assembly manufactured from materials from which the spherical bearing 10 employs. In particular, the a portion of the flat plate test specimen assembly representative of the inner ring 12 was manufactured from UNS C96900 Toughmet, another portion of the test specimen assembly representative of the outer ring 16 was manufactured from 17-4 PH stainless steel with H1025 heat treatment and the solid graphite plugs 22 installed in the pockets 20 in the portion of the test specimen assembly representative of the inner ring. The testing demonstrated the surprising result of reduced friction and increased wear life compared to other spherical bearings. For example, the break-away (i.e., static) coefficient of friction ranged between 0.013-0.28 depending on load, temperature, and wear. After running the spherical bearing 10 300 cycles of ±one inch sliding movement at ambient temperature and an 8 ksi pressure load on the spherical bearing, the temperature of the spherical bearing was elevated to 550 degrees Fahrenheit and a bearing pressure load of about 24 ksi was applied. A breakaway coefficient of friction of less than 0.15 was measured at the 550 degrees Fahrenheit temperature and 24 ksi pressure load test condition

While the present disclosure has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A bearing, comprising:
an inner ring defining a convex outer surface;
an outer ring defining a concave inner surface, the outer ring at least partially encircling the inner ring;
at least one of the outer surface and the inner surface defining a plurality of pockets; and
a solid graphite plug disposed in at least one of the plurality of pockets and slidingly engaging at least one of the outer surface and the inner surface; and
the solid graphite plug has less than 10 ppm impurities.

2. (canceled)

3. The bearing of claim 1, wherein the solid graphite plug defines a predetermined structure in an as manufactured state and after exposure to a gamma dose rate of up to 3.63×10⁴ Rad/hr.

4. The bearing of claim 1, wherein the solid graphite plug defines a predetermined structure in an as manufactured state and after exposure to a 60-yr equivalent gamma dose of 1.19×10¹⁰ Rads air.

5. The bearing of claim 1, wherein the solid graphite plug defines a predetermined structure in an as manufactured state and after exposure to a 60-yr neutron fluence dose of 4.64×10¹⁸ n/cm² with neutron energies greater than 1 MeV.

6. The bearing of claim 1, wherein the solid graphite plug defines a predetermined structure in an as manufactured state and after exposure to a temperature of up to 550° F.

7. The bearing of claim 1, wherein the solid graphite plug defines a predetermined structure in an as manufactured state and after exposure to a fluid having a pH of about 4.0 to about 4.5.

8. The bearing of claim 1, wherein the solid graphite plug defines a predetermined structure in an as manufactured state and after submergence in a fluid.

9. The bearing of claim 1, wherein the graphite plug has less than 1 ppm of at least one of aluminum, boron, calcium, iron, silicon, vanadium and titanium.

10. The bearing of claim 1, wherein the graphite plug has a porosity of 23 percent.

11. The bearing of claim 1, wherein the graphite plugs cover 35 to 50 percent of the outer surface of the inner ring and the graphite plugs are aligned in rows such that the graphite plugs in one row are spaced apart from graphite plugs in an adjacent row such that the graphite plugs have a circumferentially projected overlap of 0.01 to 0.03 inches and an axial projected overlap of 0.01 to 0.03 inches.

12. The bearing of claim 1, wherein the graphite plugs cover 45 to 48 percent of the outer surface of the inner ring and the graphite plugs are aligned in rows such that the graphite plugs in one row are spaced apart from graphite plugs in an adjacent row such that the graphite plugs have a circumferentially projected overlap of 0.01 to 0.03 inches and an axial projected overlap of 0.01 to 0.03 inches.

13. The bearing of claim 1, wherein the graphite plug has an interference fit in the pocket.

14. The bearing of claim 1, wherein the inner ring comprises a copper based alloy.

15. The bearing of claim 14, wherein the copper based alloy is one of Copper Alloy, UNS C86300 Manganese Bronze, UNS C95400 Aluminum Bronze, UNS C95400HT Heat Treated Aluminum Bronze, UNS C95500 Nickel Aluminum Bronze, UNS C95500HT Heat Treated Nickel Aluminum Bronze, UNS C96900 Spinodally Hardened Copper Alloy (ToughMet 3CX) and UNS C72900 Spinodally Hardened Copper Alloy (ToughMet 3AT).

16. The bearing of claim 1, wherein the outer ring comprises a stainless steel alloy.

17. The bearing of claim 16, wherein the stainless alloy is one of type 316, type 304 and 17-4 PH.

18. The bearing of claim 1, disposed in a support member for at least one of a reactor coolant pump and a steam generator for a nuclear power plant.

19. The bearing of claim 1, wherein the outer ring is a split ring defining a first segment and a second segment.

20. The bearing of claim 19, wherein the first segment and the second segment are removably secured to one another by at least one fastener.

21. The bearing of claim 1, wherein at least one of the graphite plugs has a distal end that is flush with the outer surface.

22. The bearing of claim 1, wherein at least one of the graphite plugs has a distal end that protrudes away from the outer surface.

23. The bearing of claim 1, wherein the outer surface and the inner surface are substantially spherical.

24. The bearing of claim 1, wherein the graphite plug has less than 1 ppm of aluminum, boron, calcium, iron, silicon vanadium and titanium.

25. The bearing of claim 1, wherein the graphite plug has a compressive strength of about 7,500 psi, a tensile strength of 2,500 psi, a flexural strength of about 4,500 psi, a modulus of elasticity of about 1.8×10⁶ psi, a coefficient of thermal expansion of about 1.1×10⁻⁶ in/in/° F., a thermal conductivity of about 80 Btu/hr-ft-° F., a density of about 1.74 g/cc, a sclerescope hardness of about 35 and an operational temperature limit of 800° F.
